(19) United States
(12) Patent Application Publication
(10) Pub. No.: US 2002/0088630 A1
(43) Pub. Date: Jul. 11, 2002

(54) Internal wall for a raceway for electric wires

(75) Inventor: Juan Manuel Benito-Navazo, Barcelona (ES)

Correspondence Address: STAAS & HALSEY LLP, 700 11TH STREET, NW, SUITE 500, WASHINGTON, DC, 20001, US

(73) Assignee: Aparellaje Electrico, S.L., Barcelona (ES)

(21) Appl. No.: 10/028,280

(22) Filed: Dec. 28, 2001

(30) Foreign Application Priority Data
Jan. 11, 2001 (ES) 200100053

(51) Int. Cl. H02G 3/04

(52) U.S. Cl. 174/48

(57) ABSTRACT

An internal longitudinal compartmentalization wall for a raceway for electrical wires is provided with spaced apart transfer areas (4) susceptible of placing two adjacent compartments (3a, 3b) in communication with each other, determining openings (5) to allow the electrical wires (6) to pass from one to another of adjacent compartments (3a, 3b).

### FIELD OF THE INVENTION

The present invention relates to an internal wall for a raceway for electric wires, to be precise to a longitudinal compartmentalization wall for a raceway for electric wires of the type constituted by a base section and a removable cover section, engageable with the aforementioned base section, both made from synthetic plastic insulating material.

### PRIOR ART

When mounting electrical installations with the said raceways compartmentalized by one, two or more internal walls, it frequently happens that if one compartment is used only for mounting electrical mechanisms, such as power outlets, and the remaining compartments are used for locating electrical conductors, the need arises for some cables in a particular remaining compartment to be diverted into the said one compartment, whereby on-the-spot solutions have to be adopted, such as opening a gap or a window in the internal wall, which, in many cases is little less than impossible, especially in the case of installations which are in service.

Another case where this need arises is when it is wanted to make a derivation in “T” of a raceway and wires have to be routed from the compartment farthest removed from the “T.”

As is understood, it would be desirable to arrange the raceways in question so that the internal longitudinal compartmentalization walls thereof were provided with means that allowed for communication from one compartment to the adjacent ones, in the same way as with the external walls of the raceways used for electrical panels.

### SUMMARY OF THE INVENTION

In order to fulfil the foregoing premise, the solution has been adopted of forming in the intermediate walls of the raceways in question spaced apart arrangements that easily allow the wires to pass from one compartment to the adjacent one at points close to the point where the need arises.

In accordance with the foregoing solution, the internal wall of the present invention has been developed, which internal compartmentalization wall is provided with spaced apart transfer areas susceptible of placing two adjacent compartments in communication with each other, determining openings of sufficient section to allow the electric wires to pass from one compartment to the other.

Certain features consist of the transfer areas being constituted by closed figures defined by lines of weakening and that such figures of the transfer areas comprise die-cut lines and at least one line of weakening and/or folding or, simply, die-cut defining through openings, that is to say, openings sufficiently large such as to allow the electric wires to pass therethrough. These openings may be provided with removable stopping means.

On the other hand, the invention contemplates that the intermediate wall is fixedly attached to the base section, or may be removably engageable therewith.

### BRIEF DESCRIPTION OF THE DRAWINGS

To facilitate the understanding of the foregoing ideas, the object of the invention is described hereinafter, with reference to the accompanying illustrative drawings, in which:

FIG. 1 is a perspective view of aligned fragments of an internal compartmentalization wall of the base section for a raceway for electric conductors.

FIG. 2 is a cross section view along the line II-II of FIG. 1.

FIG. 3 is a plan view of a central portion of a base section of a raceway wherein an electrical apparatus installed in one compartment is connected to an electrical conductor coming from another compartment.

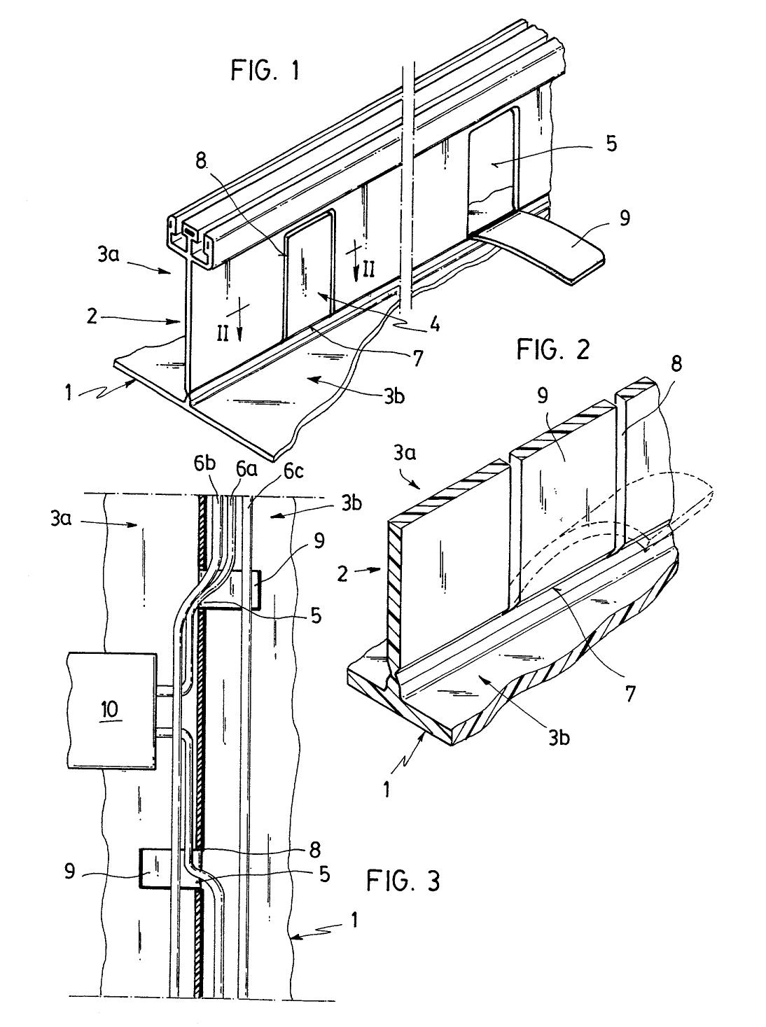

### DETAILED DESCRIPTION OF THE INVENTION

In the drawings there is shown alone and fragmentarily the base section 1 of a raceway for electric wires provided with an internal wall 2 that separates two compartments 3a and 3b of said raceway.

According to the invention, said internal wall 2 is provided with transfer areas 4 spaced apart at a distance of about twelve centimeters and susceptible of placing two adjacent compartments 3a and 3b in communication with each other, defining openings 5 of sufficient section to allow the electric wires 6 to pass from one of said compartments 3a or 3b to the other.

The transfer areas 4 are formed by closed figures defined by lines of weakening or folding 7 and/or die-cut lines 8.

In the case shown in the drawings, the transfer areas 4 are formed by three die-cut extents 8 and a lower extent that can be folded over simply or with the aid of a line of weakening or perforated line 7.

The line of weakening 7 can be continuous along the base of the internal wall or be marked in each transfer area 4 at the time of producing the die-cut lines 8.

As may be seen in the Figures, when the openings 5 are made, the transfer areas 4 define tongues 9 that extend into one or the other of the compartments 3a and 3b.

FIG. 3 shows how one electrical wire 6a supplies an electrical apparatus 10, passing from compartment 3b to compartment 3a and returning to the former, at the same time as an electrical wire 6b passes from compartment 3b to 3a and another electrical wire 6c remains in compartment 3b.

What I claim is:

1. An internal longitudinal compartmentalization wall for a raceway for electrical lines, wherein said internal compartmentalization wall (2) is provided with spaced apart transfer areas (4) susceptible of placing two adjacent compartments (3a, 3b) in communication with each other, determining openings (5) to allow the electrical wires (6) to pass from one to another of adjacent compartments (3a, 3b).

2. The internal wall (2) according to claim 1, wherein the transfer areas (4) are formed by closed figures defined by lines of weakening (7).

3. The internal wall (2) according to claim 1, wherein the transfer areas (4) are formed by closed figures defined by die-cut lines (8) and by at least one line of weakening and/or folding (7).

4. The internal wall (2) according to claim 2 or claim 3, wherein the figures of the transfer areas (4) are formed die-cuts defining through openings (5).

5. The internal wall (2) according to claim 4, wherein the through openings (5) are susceptible of having removable stopping means.

6. The internal wall (2) according to claim 1, being integral with the base section (1) of the raceway.

7. The internal wall (2) according to claim 1, wherein it forms an element removably attachable to the bottom of the base section (1) of the raceway.
